(19) United States
(12) Patent Application Publication
(10) Pub. No.: US 2022/0411641 A1
(43) Pub. Date: Dec. 29, 2022

(54) UV CURED CROSS-LINKED ABRASION RESISTANT LIQUID CERAMIC NANO-COMPOSITE

(71) Applicant: Unmatched Bonding Company, LLC, Fort Worth, TX (US)

(72) Inventor: Ryan Michael Jones, Colbert, WA (US)

(21) Appl. No.: 17/641,619

(22) PCT Filed: Sep. 11, 2020
(86) PCT No.: PCT/US20/50397

§ 371 Date: Mar. 9, 2022

Related U.S. Application Data
(60) Provisional application No. 62/898,614, filed on Sep. 11, 2019.

(51) Int. Cl. C09D 4/06; C09D 167/06; C09D 133/02; C09D 135/02; C09D 167/02; C09D 7/61; C09D 7/40; C04B 41/00; C04B 41/83; C04B 41/48

(52) U.S. Cl. CPC C09D 4/06; C09D 167/06; C09D 133/02; C09D 135/02; C09D 167/02; C09D 7/61; C09D 7/70; C04B 41/009; C04B 41/83; C04B 41/0045; C04B 41/4876; C04B 41/4826; C08K 2003/2227

(57) ABSTRACT

A UV-cured cross-linked liquid resin reinforced with ceramic inorganic nano-particles and ceramic inorganic abrasion-resistant powder, comprised of 30%-45% by weight resin, wherein the resin is at least one of 2-propenoic acid, homopolymer, isophthalic acid, 1,4-Dimethoxybenzene, saturated polyester resin, and maleic anhydride; 10%-20% by weight industrial ceramic inorganic nano-materials; 30%-45% by weight industrial ceramic inorganic abrasion-resistant powder; and styrene, wherein the styrene is less than 25% by weight of the UV-cured cross-linked liquid resin reinforced with ceramic inorganic nano-particles and ceramic inorganic abrasion-resistant powder.

### CROSS-REFERENCE TO RELATED APPLICATIONS

The present application claims the benefit of the filing date of U.S. Provisional Patent Application Ser. No. 62/898,614 filed by the present inventor on Sep. 11, 2019.

The aforementioned provisional patent application is hereby incorporated by reference in its entirety.

### STATEMENT REGARDING FEDERALLY SPONSORED RESEARCH OR DEVELOPMENT

None.

### BACKGROUND OF THE INVENTION

### Field of the Invention

The present invention relates to materials and products for repair of abrasion-resistant, non-decorative tile, brick or plate for bulk materials handling, military applications and aerospace applications.

### Brief Description of the Related Art

Non-decorative industrial grade tile has been in use for many years. Installed tile at times needs to be repaired due to wear (or abrasion) on the tile. Materials used for such repairs can be referred to as “wear components” or “wear material.”

A significant drawback of current industrial ceramic wear components is the permanent rigidness of the components. This rigidness prevents the wear material from being shaped to fit into custom applications. Cutting and/or breaking the ceramic wear components to fit to size on custom applications comes at a great inconvenience and expense, while greatly reducing overall quality and performance. When faced with countless problems while doing industrial repairs and/or installing Industrial Ceramic Abrasion Resistant components, such as filling gaps and shaping and molding custom parts on the spot. Using conventional methods requires countless hours of cure time and breaking or cutting ceramic parts with great expense and inconvenience.

### SUMMARY OF THE INVENTION

In a preferred embodiment, the present invention is UV cured cross-linked liquid resin reinforced with, e.g., impregnated with, ceramic inorganic nanoparticles and ceramic inorganic abrasion-resistant powder. The UV cured resin achieves at least ⅛″ of fully cured material within 5 minutes when exposed to appropriate UV light. The UV-cured cross-linked liquid resin reinforced with ceramic inorganic nano-particles and ceramic inorganic abrasion-resistant powder is comprised of 30%-45% by weight resin, wherein the resin is at least one of 2-propenoic acid, homopolymer, isophthalic acid, 1,4-Dimethoxybenzene, saturated polyester resin, and maleic anhydride; 10%-20% by weight industrial ceramic inorganic nano-materials; 30%-45% by weight industrial ceramic inorganic abrasion-resistant powder; and styrene, wherein the styrene is less than 25% by weight of the UV-cured cross-linked liquid resin reinforced with ceramic inorganic nano-particles and ceramic inorganic abrasion-resistant powder.

The UV-cured cross-linked liquid resin reinforced with ceramic inorganic nanoparticles and ceramic inorganic abrasion-resistant powder may be comprised of 45% resin by weight. The industrial ceramic inorganic nanomaterials may comprise aluminum hydroxide. The industrial ceramic inorganic abrasion-resistant powder comprises at least one of silicon dioxide, amorphous, fumed silica and/or silica glass. The industrial ceramic inorganic nanomaterials and the industrial ceramic inorganic abrasion-resistant powder together may make up 50-60% of the UV-cured cross-linked liquid resin reinforced with ceramic inorganic nanoparticles and ceramic inorganic abrasion-resistant powder by weight. The industrial ceramic inorganic nanomaterials and the industrial ceramic inorganic abrasion-resistant powder together make up 55% of the UV-cured cross-linked liquid resin reinforced with ceramic inorganic nanoparticles and ceramic inorganic abrasion-resistant powder by weight.

In another preferred embodiment, the present invention is a method for repairing an industrial material. The method comprises preparing a surface of an industrial material such as by cleaning the surface, filling gaps in the prepared surface of the industrial material with a UV-cured cross-linked liquid resin reinforced with ceramic inorganic nano-particles and ceramic inorganic abrasion-resistant powder, and applying ultra-violet light to the UV-cured cross-linked liquid resin reinforced with ceramic inorganic nano-particles and ceramic inorganic abrasion-resistant powder. The UV-cured cross-linked liquid resin reinforced with ceramic inorganic nano-particles and ceramic inorganic abrasion-resistant powder comprises 30%-45% by weight resin, wherein the resin is at least one of 2-propenoic acid, homopolymer, isophthalic acid, 1,4-Dimethoxybenzene, saturated polyester resin, and maleic anhydride; 10%-20% by weight industrial ceramic inorganic nano-materials; 30%-45% by weight industrial ceramic inorganic abrasion-resistant powder; and styrene, wherein the styrene is less than 25% by weight of the UV-cured cross-linked liquid resin reinforced with ceramic inorganic nano-particles and ceramic inorganic abrasion-resistant powder.

The industrial material may comprise abrasion-resistant industrial ceramic tile.

In yet another embodiment, the present invention is a system for repairing an industrial material. The system comprises an applicator and a UV-cured cross-linked liquid resin reinforced with ceramic inorganic nanoparticles and ceramic inorganic abrasion-resistant powder. The UV-cured cross-linked liquid resin reinforced with ceramic inorganic nanoparticles and ceramic inorganic abrasion-resistant powder comprises 30%-45% by weight resin, wherein the resin is at least one of 2-propenoic acid, homopolymer, isophthalic acid, 1,4-Dimethoxybenzene, saturated polyester resin, and maleic anhydride; 10%-20% by weight industrial ceramic inorganic nanomaterials; 30%-45% by weight industrial ceramic inorganic abrasion-resistant powder; and styrene, wherein the styrene is less than 25% by weight of the UV-cured cross-linked liquid resin reinforced with ceramic inorganic nano-particles and ceramic inorganic abrasion-resistant powder.

Still other aspects, features, and advantages of the present invention are readily apparent from the following detailed description, simply by illustrating a preferable embodiments and implementations. The present invention is also capable of other and different embodiments and its several details can be modified in various obvious respects, all without departing from the spirit and scope of the present invention. Accordingly, the drawings and descriptions are to be regarded as illustrative in nature, and not as restrictive. Additional objects and advantages of the invention will be set forth in part in the description which follows and in part will be obvious from the description or may be learned by practice of the invention.

### BRIEF DESCRIPTION OF THE DRAWINGS

For a more complete understanding of the present invention and the advantages thereof, reference is now made to the following description and the accompanying drawings, in which:

FIG. 1 is a flow chart illustrating a method of applying a UV cured cross-linked liquid resin in accordance with a preferred embodiment of the present invention.

FIGS. 2A-2D are photos illustrating and exemplary method for applying a UV cured cross-linked liquid resin in accordance with a preferred embodiment of the present invention.

FIG. 3 is a photo of tiles after application of a UV cured cross-linked liquid resin in accordance with a preferred embodiment of the present invention.

FIG. 4 is a photo of a bolt encapsulated with a UV cured cross-linked liquid resin in accordance with a preferred embodiment of the present invention.

### DETAILED DESCRIPTION OF THE PREFERRED EMBODIMENTS

Instead of attempting costly and potentially dangerous conventional methods, the end user needs a one-component thixotropic paste that can be formed into virtually any shape and cured to extreme strength and hardness within minutes. Essentially, a high strength “industrial ceramic parts factory in a tube” is needed. There is an extreme need in virtually all industries for a molding material where an average citizen can make strong custom parts and/or make quality permanent custom repairs in minutes.

The present invention is a UV cured cross-linked liquid resin reinforced with ceramic inorganic nanoparticles and ceramic inorganic abrasion-resistant powder comprised of the following in percentages by weight:
30%-45% resin from any of 2-propenoic acid, homopolymer (CAS Nos. 9003-01-4), Isophthalic acid (CAS No. 121-91-5), 1,4-Dimethoxybenzene (CAS No. 150-78-7, dimethyl 5-sodiosulfoisophthalate-ethylene glycol-isophthalic acid-terephthalic acid copolymer (CAS No. 61926-16-7), or Maleic anhydride (CAS No. 108-31-6);
10%-20% industrial ceramic inorganic nanomaterials including aluminum hydroxide (CAS No. 21654-51-2);
30%-45% industrial ceramic inorganic abrasion-resistant powder such as silicon dioxide (CAS No. 14808-60-7), amorphous, fumed silica (CAS No. 112945-52-5) and/or silica glass (CAS No. 60676-86-0); and
styrene (less than 25%) (CAS NO. 100-42-5).

This composition forms a UV cured industrial paste for repair of wear-resistant (or abrasion-resistant) material and casting custom parts. The UV cured resin must achieve at least ⅛″ of fully cured material in less than 5 minutes when exposed to the appropriate UV Light. When the UV activated resin is fully cured and hardened it must attain a hardness of greater than 60 Barcol using the Barcol impresser scale. The resin preferably comprises about 45% of the nanocomposite by weight. The ceramic inorganic materials and abrasion resistant powder together preferably comprise 50%-60%, and preferably about 55%, of the nanocomposite by weight.

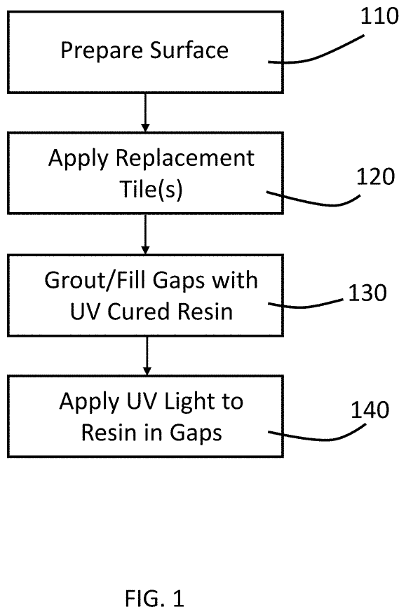

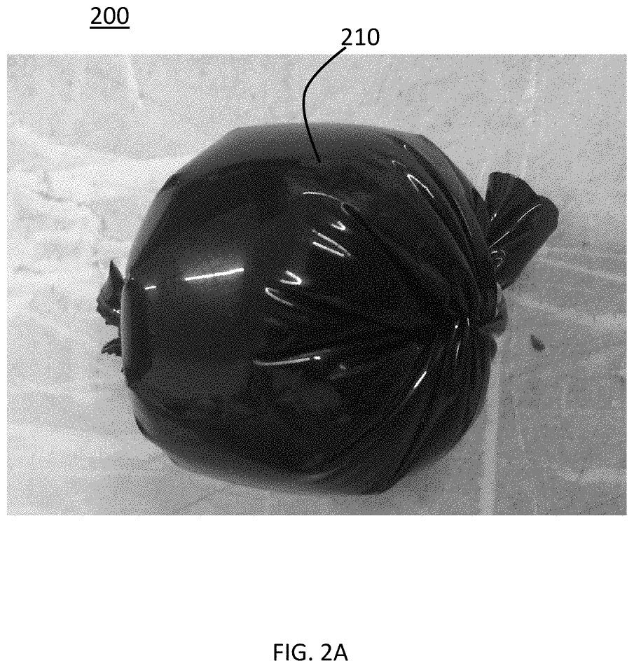

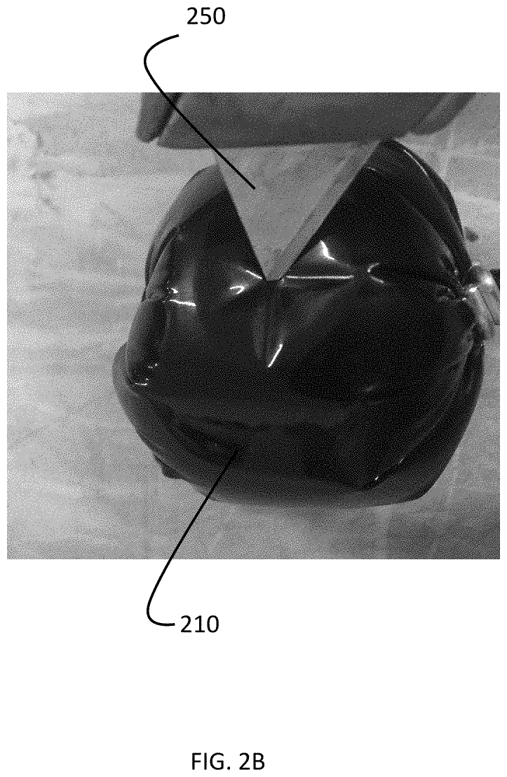

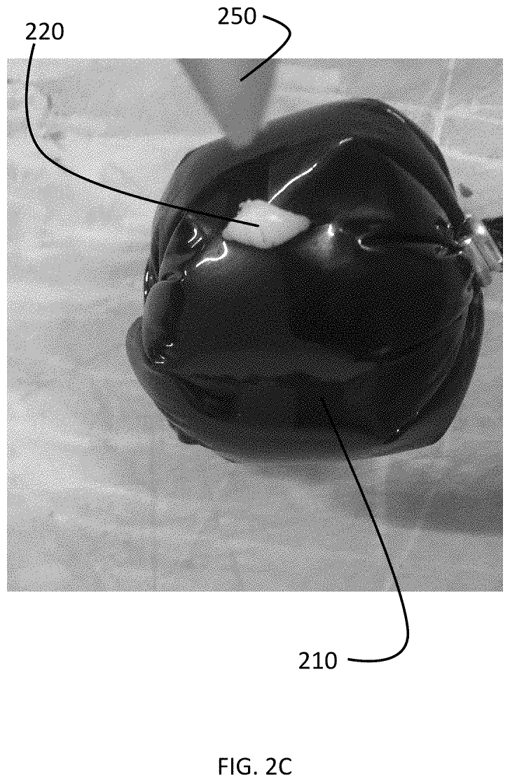

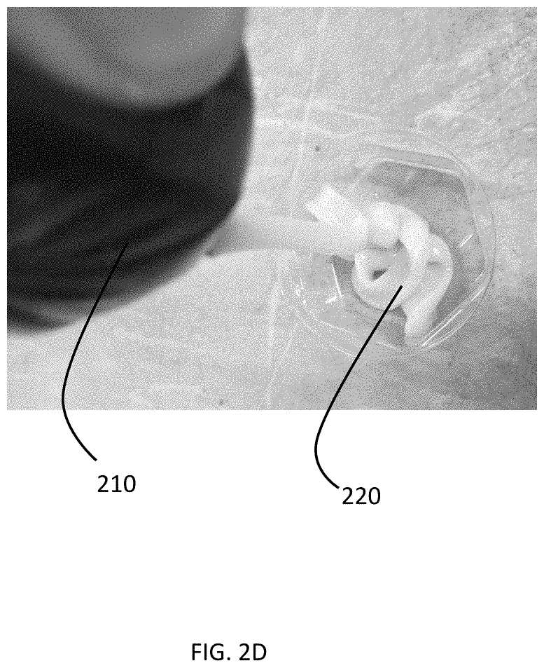

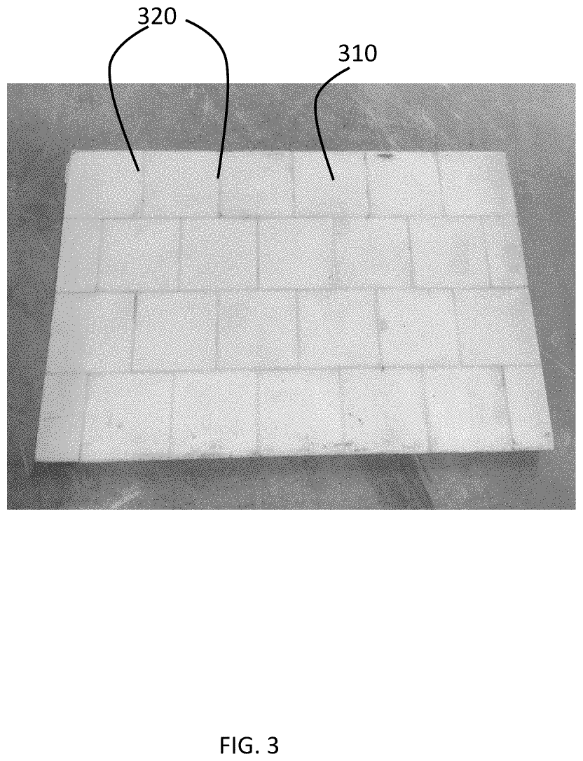

As shown in FIGS. 1 and 3, in the context of non-decorative industrial tile, the present invention can be used in repairing/replacing tiles. First, the surface is prepared for application of replacement tiles, for example, by removing broken tiles and/or cleaning the surface where tiles have been removed or have fallen off (step 110). Next, a replacement tile 310 is applied (step 120). The replacement tile 310, for example, may be a tile such as is disclosed in Published International Patent Application No. WO 2020/005730, entitled “Non-Decorative Industrial Grade Self-Adhesive Tile And Method Of Manufacturing Thereof.” Once the replacement tile 310 is in place, the UV cured industrial paste of the present invention is used to fill/grout the gaps 320 between tiles (step 130). UV light is then applied to the UV cured industrial paste in the gaps to cure the paste (step 140). The UV light is applied for 1-5 minutes, and preferably is applied for 4-5 minutes. An exemplary tile after completion of the application of the UV light is shown in FIG. 3. Ns. The UV cured industrial paste of the present invention may be applied in any appropriate manner. An exemplary application is shown in FIGS. 2A-2D. The paste 220 is placed within a flexible opaque material such as plastic 210. The flexible material 210 is then punctured with a knife, box cutter or the like 250 to create an opening in the flexible material 210. The flexible material is then squeezed to apply the paste to the gaps in the tile.

The present invention may be used with other types of applicators and is by no means limited to this particular applicator. For example, the US cured industrial paste of the present invention could be placed within a housing or container having a plunger to push the paste out of a nozzle. Such a container could be made of any of many different materials, including but not limited to plastic. Any of these or many other known means for holding the paste and applying it may be referred to as an “applicator.”

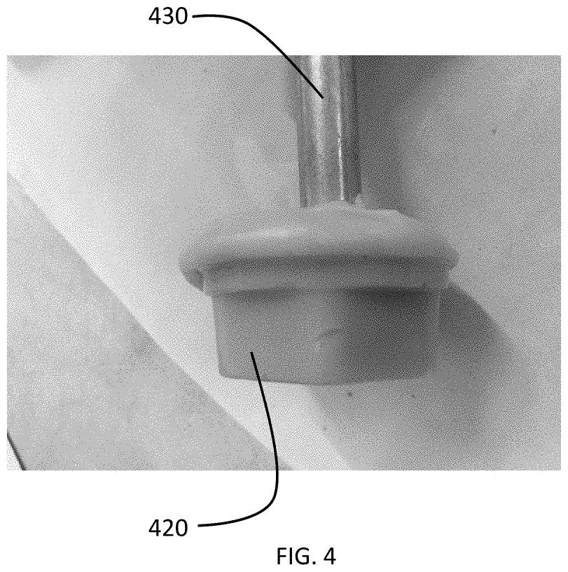

The UV cured resin of the present invention may have many other applications, such as to encapsulate a bolt as shown in FIG. 4.

The materials and products according to the present invention may be used, for example, for repair of abrasion-resistant, non-decorative tile, brick or plate for bulk materials handling, military applications and aerospace applications including, but not limited to, General Aerospace Repair, Aerospace Composite Repair, Carbon Fiber Repair, Automotive Composite Repair and other Advanced Composite Repair.

A significant drawback during Aerospace repair and other advanced composite repair are the lengthy cure times coupled with labor intensive multipart resin components. Mandatory cold storage of resins and the specialized heat equipment required for high temperature induced curing methods leads to costly and extremely time-consuming repairs.

The Aerospace Industry and advanced composite repair industry are in great need of a One-Part UV cured Nano-Composite that can literally achieve full cure of at least ⅛″ in less than 5 minutes. The nanocomposite of the present invention can be stored at room temperature and maintain its stability and viability for 2, 3, or even 5 or more years.

The one-part nano-composite of the present invention can also reinforce or be reinforced with a multitude of various fillers, fibers and/or composites including, but not limited to: Chopped Carbon Fiber, Continuous Carbon Fiber, Kevlar, Dyneema, Woven Reinforcements, Multiaxial Reinforcements, Honeycomb, Ceramic Fibers, Aluminum Fibers, Quartz Fabric, Man Made Vitreous Fiber, Glass Fiber Mats, Glass Fiber chopped strand mats, Polyamide Fabrics, Fiber Reinforcements (Fibers, whiskers, particles), Rigid Foam, Wood, Metal, Paper Honeycomb, Nomex Honeycomb, Carbon Honeycomb, Fiberglass Honeycomb, Metal Honeycomb, Fiberglass Cloth, Nylon, Cotton, Nylon Thermoplastic Fibers, Polyester Thermoplastic Fibers, E-Glass, E-CR Glass, S-Glass, Alumina-Lime-Borosilicate, Aramid Fibers (Polyaramids), CARBON FIBERS, Graphite Fibers (>99% Carbon Fibers), Spider Silk (Natural), Spider Silk (Man-Made) Aromatic Polyamid, Man-Made Organic Fibers, Aluminum Oxide nano-particles, Aluminum Hydroxide nano-particles, Graphene, Halloysite, Wollastonite, Talc, Mica, Glass Beads, Hollow glass, Roving Mat, Milled Fiber Mat, Chopped Strand Mat, Continuous Fiber May, Thermoform-able Mat, Multi-End Rovings, Single-End Rovings Filament winding applications, Pultrusion applications, Non-Woven Veils, Soluble & Insoluble Fibers, Unidirectional reinforcements, Tapes, Tows, unidirectional tow sheet and roving, Monocrystalline Whiskers, Polymer-Matrix-Composites, Metal-Matrix-Composites, Ceramic-Matrix-Composites, Silicon Carbide, Carbon Nano Tubes, Titanium Dioxide, Titanium Carbide, Unidirectional Tapes, Non-Crimp Fabrics, Dry Carbon Fabrics, Yarns, Petroleum Pitch, Polyacrylonitrile, Rayon, phenolic micro-balloons, plastic micro-balloons, Reactive Carbon Nano-Fibers, Nano-Cellulose, and Cellulose Nano-Crystal.

The foregoing description of the preferred embodiment of the invention has been presented for purposes of illustration and description. It is not intended to be exhaustive or to limit the invention to the precise form disclosed, and modifications and variations are possible in light of the above teachings or may be acquired from practice of the invention. The embodiment was chosen and described in order to explain the principles of the invention and its practical application to enable one skilled in the art to utilize the invention in various embodiments as are suited to the particular use contemplated. It is intended that the scope of the invention be defined by the claims appended hereto, and their equivalents. The entirety of each of the aforementioned documents is incorporated by reference herein.

What is claimed is:

1. A UV-cured cross-linked liquid resin reinforced with ceramic inorganic nanoparticles and ceramic inorganic abrasion-resistant powder, comprising:
30%-45% by weight resin, wherein said resin is at least one of 2-propenoic acid, homopolymer, isophthalic acid, 1,4-Dimethoxybenzene, saturated polyester resin, and maleic anhydride;
10%-20% by weight industrial ceramic inorganic nanomaterials;
30%-45% by weight industrial ceramic inorganic abrasion-resistant powder; and
styrene, wherein said styrene is less than 25% by weight of said UV-cured cross-linked liquid resin reinforced with ceramic inorganic nano-particles and ceramic inorganic abrasion-resistant powder.

2. A UV-cured cross-linked liquid resin reinforced with ceramic inorganic nano-particles and ceramic inorganic abrasion-resistant powder according to claim 1, wherein said UV-cured cross-linked liquid resin reinforced with ceramic inorganic nano-particles and ceramic inorganic abrasion-resistant powder is comprises of 45% resin by weight.

3. A UV-cured cross-linked liquid resin reinforced with ceramic inorganic nanoparticles and ceramic inorganic abrasion-resistant powder according to claim 1, wherein said industrial ceramic inorganic nano-materials comprise aluminum hydroxide.

4. A UV-cured cross-linked liquid resin reinforced with ceramic inorganic nano-particles and ceramic inorganic abrasion-resistant powder according to claim 1, wherein said industrial ceramic inorganic abrasion-resistant powder comprises at least one of silicon dioxide, amorphous, fumed silica and/or silica glass.

5. A UV-cured cross-linked liquid resin reinforced with ceramic inorganic nano-particles and ceramic inorganic abrasion-resistant powder according to claim 1, wherein said industrial ceramic inorganic nano-materials and said industrial ceramic inorganic abrasion-resistant powder together make up 50-60% of said UV-cured cross-linked liquid resin reinforced with ceramic inorganic nano-particles and ceramic inorganic abrasion-resistant powder by weight.

6. A UV-cured cross-linked liquid resin reinforced with ceramic inorganic nano-particles and ceramic inorganic abrasion-resistant powder according to claim 1, wherein said industrial ceramic inorganic nano-materials and said industrial ceramic inorganic abrasion-resistant powder together make up 55% of said UV-cured cross-linked liquid resin reinforced with ceramic inorganic nano-particles and ceramic inorganic abrasion-resistant powder by weight.

7. A UV-cured cross-linked liquid resin reinforced with ceramic inorganic nanoparticles and ceramic inorganic abrasion-resistant powder according to claim 1, further comprising a filler, wherein said filler comprises at least one of:
chopped carbon fiber, continuous carbon fiber, kevlar, dyneema, woven reinforcements, multiaxial reinforcements, honeycomb, ceramic fibers, aluminum fibers, quartz fabric, man-made vitreous fiber, glass fiber mats, glass fiber chopped strand mats, polyamide fabrics, fiber reinforcements (fibers, whiskers, particles), rigid foam, wood, metal, paper honeycomb, nomex honeycomb, carbon honeycomb, fiberglass honeycomb, metal honeycomb, fiberglass cloth, nylon, cotton, nylon thermoplastic fibers, polyester thermoplastic fibers, e-glass, e-cr glass, s-glass, alumina-lime-borosilicate, aramid fibers, carbon fibers, graphite fibers, spider silk, man-made spider silk, aromatic polyamid, man-made organic fibers, aluminum oxide nano-particles, aluminum hydroxide nano-particles, graphene, halloysite, wollastonite, talc, mica, glass beads, hollow glass, roving mat, milled fiber mat, chopped strand mat, continuous fiber may, thermoform-able mat, multi-end rovings, single-end rovings filament winding applications, pultrusion applications, non-woven veils, soluble & insoluble fibers, unidirectional reinforcements, tapes, tows, unidirectional tow sheet and roving, monocrystalline whiskers, polymer-matrix-composites, metal-matrix-composites, ceramic-matrix-composites, silicon carbide, carbon nano tubes, titanium dioxide, titanium carbide, unidirectional tapes, non-crimp fabrics, dry carbon fabrics, yarns, petroleum pitch, polyacrylonitrile, rayon, phenolic micro-balloons, plastic micro-balloons, reactive carbon nano-fibers, nano-cellulose, and cellulose nano-crystal.

8. A method for repairing an industrial material comprising:
preparing a surface of an industrial material;
filling gaps in said prepared surface of said industrial material with a UV-cured cross-linked liquid resin reinforced with ceramic inorganic nanoparticles and ceramic inorganic abrasion-resistant powder, comprising:
30%-45% by weight resin, wherein said resin is at least one of 2-propenoic acid, homopolymer, isophthalic acid, 1,4-Dimethoxybenzene, saturated polyester resin, and maleic anhydride;
10%-20% by weight industrial ceramic inorganic nano-materials;
30%-45% by weight industrial ceramic inorganic abrasion-resistant powder; and
styrene, wherein said styrene is less than 25% by weight of said UV-cured cross-linked liquid resin reinforced with ceramic inorganic nano-particles and ceramic inorganic abrasion-resistant powder;
applying ultra-violet light to said UV-cured cross-linked liquid resin reinforced with ceramic inorganic nanoparticles and ceramic inorganic abrasion-resistant powder.

9. A method for repairing an industrial material according to claim 8, wherein said industrial material comprises abrasion-resistant industrial ceramic tile.

10. A system for repairing an industrial material comprising;
an applicator; and
a UV-cured cross-linked liquid resin reinforced with ceramic inorganic nanoparticles and ceramic inorganic abrasion-resistant powder, comprising:
30%-45% by weight resin, wherein said resin is at least one of 2-propenoic acid, homopolymer, isophthalic acid, 1,4-Dimethoxybenzene, saturated polyester resin, and maleic anhydride;
10%-20% by weight industrial ceramic inorganic nanomaterials;
30%-45% by weight industrial ceramic inorganic abrasion-resistant powder; and
styrene, wherein said styrene is less than 25% by weight of said UV-cured cross-linked liquid resin reinforced with ceramic inorganic nano-particles and ceramic inorganic abrasion-resistant powder.
